(19) United States
(12) Patent Application Publication
(10) Pub. No.: US 2023/0038672 A1
(43) Pub. Date: Feb. 9, 2023

(54) MECHANISM TO DETERMINE CABLE INFORMATION

(71) Applicant: Intel Corporation, Santa Clara, CA (US)

(72) Inventors: Nan Wang, Shanghai (CN); Zhiming Li, Shanghai (CN); Rudong Shi, Shanghai (CN); Francisco Javier Lasa Gutierrez, Zapopan (MX)

(73) Assignee: Intel Corporation, Santa Clara, CA (US)

(21) Appl. No.: 17/972,670

(22) Filed: Oct. 25, 2022

(30) Foreign Application Priority Data
Sep. 30, 2022 (CN) PCT/CN2022/123564

(51) Int. Cl. G06F 13/20

(52) U.S. Cl. CPC G06F 13/20; G06F 2213/40

(57) ABSTRACT

One or more processors of a computing system, such as a server architecture, such as a disaggregated server architecture. The one or more processors are to access cable information pertaining to a cable coupled to an I/O port of the computing system. The one or more processors are to configure a first memory circuitry of the computing system based on the cable information. A cable structure includes the cable, and further includes a second memory circuitry storing the cable information, and accessible by the one or more processors.

### CROSS-REFERENCE TO RELATED APPLICATION

This application claims the benefit of International Application No. PCT/CN2022/123564, filed Sep. 30, 2022.

### FIELD

The present disclosure relates in general to the field of computer architecture, and more specifically, though not exclusively, to rack scale architecture and disaggregated servers.

### BACKGROUND

In current server designs, cable integration within a data center network involves maintaining various circuit boards having a same Printed Circuit Board Assembly (PCBA) design, such as backplanes or Peripheral Component Interconnect Express (PCIe) extenders, etc., as different Stock Keeping Units (SKUs) because of different Field Replaceable Unit (FRU) information or of different System Integration (SI) settings in firmware relating to different cables that may have been integrated within the network, and/or to different locations (e.g., customer sites) where the cable may have been deployed.

For the same backplanes or for the same PCIe extenders in different locations, the state of the art has further used identification (ID) pins to identify different server configurations, for example in the context of disaggregated servers. Regardless of whether information may be discernable regarding any particular server configuration from an ID pin of a circuit board, circuit boards of a same design would still need to be reprogrammed in the case of cabling changes in order to maintain SKU configurations that correspond to the FRU information or SI setting of corresponding cables being used. However, in the state of the art, SI settings and FRU information are preset with respect to the Basic Input Output System (BIOS), the re-timer and EEPROM of a circuit board.

### BRIEF DESCRIPTION OF THE DRAWINGS

FIG. 1 is a diagram of a conceptual overview of a data center in which one or more techniques described herein may be implemented according to various embodiments.

FIG. 2 is a diagram of an example embodiment of a logical configuration of a rack of the data center of FIG. 1.

FIG. 3 is a diagram of an example embodiment of another data center in which one or more techniques described herein may be implemented according to various embodiments.

FIG. 4 is a diagram of another example embodiment of a data center in which one or more techniques described herein may be implemented according to various embodiments.

FIG. 5 is a diagram of a connectivity scheme representative of link-layer connectivity that may be established among various sleds of the data centers of FIGS. 1, 3, and 4.

FIG. 6 is a perspective view of a cable structure according to an embodiment.

FIG. 7 is a diagram of an assembly including a motherboard and a cable structure according to one embodiment.

FIG. 8 is a diagram of an assembly including a motherboard, backplane and cable structures according to an embodiment.

FIG. 9 is a diagram of an assembly including a motherboard, storage boards, extenders and cable structures according to an embodiment.

FIG. 10 is a diagram of an assembly including two motherboards coupled to one another by way of a cable structure according to an embodiment.

FIG. 11 is a diagram of an assembly including a motherboard coupled to a backplane through a Flex I/O port and three different cables.

FIG. 12 is a diagram of a process flow according to one embodiment.

### DETAILED DESCRIPTION

The concept of modular/disaggregated servers has become ever more popular as the technology of rack scale architecture (RSA) progresses. The concept is apt to provide, efficiency, flexibility, and scalability to data centers. Current developments surrounding modular servers envision interoperability between key elements of a data center, edge and enterprise infrastructure by providing consistent interfaces and form factors among modular building blocks.

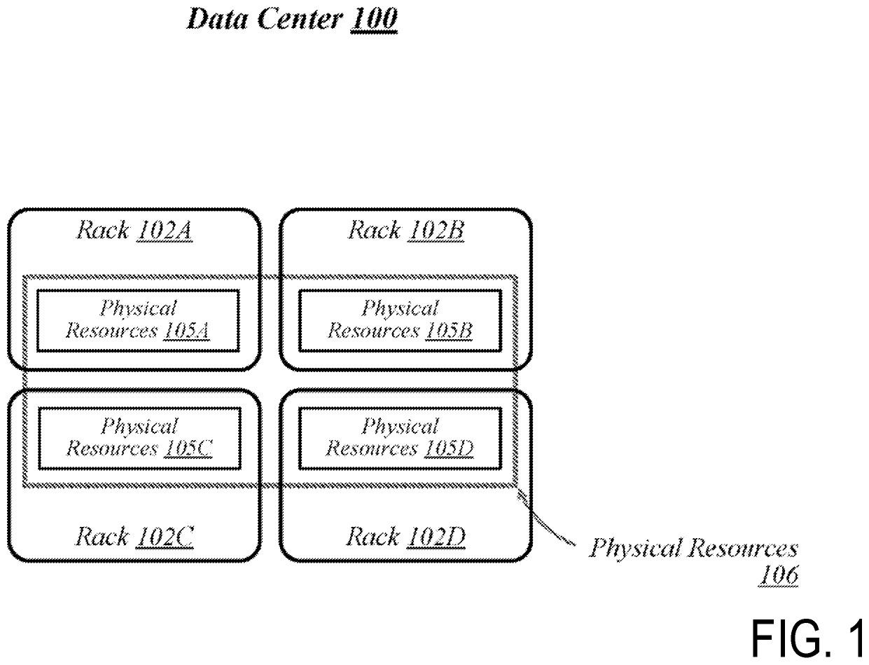

In modular design, the server chassis is decoupled to different components, such as a compute block, storage block, GPU block, network block, cooling block, power block and so on, as will be described in further detail below in the context of example architectures of FIGS. 1-5.

A “component” of a modular server architecture may correspond to a circuitry it perform a function, such as an Application Specific Integrated Circuit (ASIC) of the modular server architecture, such as circuitry for compute, storage, GPU, network, or cooling, power, etc. as mentioned above. A “component” as referred to herein may for example correspond to a physical resource within the server architecture in a rack corresponding to a modular server architecture as described in further detail below in the context of example architectures of FIGS. 1-5.

Individual components may be associated with their corresponding circuit board (or “circuit board”). For example, a circuit board may correspond to a motherboard, a backboard, a PCIe extender circuit board (e.g., with a re-timer functionality), or any physical circuit board that corresponding to a component of a modular server architecture.

A “cable” as referred to herein refers to any communication (e.g., data (control or signal) or power) physical pathway of a data center, such as between a motherboard and a backplane. A “cable” as used herein may further include, for example a fiber optic cable (e.g. a multistrand fiber optic cable), or a metallic cable (e.g., including copper). The optical fabric including a “cable” as referred to herein may correspond to any of the optical fabrics described below in the context of example architectures of FIGS. 1-5. A “cable” as referred to herein may be for high-speed or low-speed signal transmission in a server architecture.

A “cable” as referred to herein may adhere to a cabling standard for data centers, such as, for example, an Ethernet cable, a Gigabit Ethernet cable, a 10 Gig Ethernet cable, a 10 or 100 Gig Ethernet cable, a High Speed Ethernet cable (e.g., using a fiber channel or using a fiber optic channel (such as a multimode or a single mode cable)).

A “contact” as referred to herein, such as a “power contact” or a “signal contact” may include any physical feature that is to be coupled to a communication path (i.e., a wire, a cable, etc.) to communicate, respectively, power or data signals. A contact may include, for example, a pin, a slot, a pad, etc.

By “FRU settings,” “FRU parameters” or “FRU information,” as referred to herein, what is meant is settings, parameters or information relating to any aspect of a data center component for which the settings, parameters or information is provided. The FRU information may include information including at least one of part number, version number, serial number, and/or any other information that identifies the type or operational parameters (including SKU information or other software information) relating the component in question.

By “SI settings” or “SI parameters” as referred to herein, what is meant is settings or parameters for a first element for example of a server architecture (such as a circuit board of a server architecture, including a port or ports of the circuit board) that are configurable/programmable (whether adaptively or not) to this first element, and that relate to the integration with/coupling to the first element, of a second element of the server architecture (such as a cable). SI settings or SI parameters as used herein, when configured, are to provide interoperability as between the first element and the second element. By way of example, SI settings of a circuit board of a server may overlap with FRU information of a given cable, which may mean that the cable may be integrated with the circuit board where there is a match between FRU information of the given cable and SI settings of the component with which the cable is coupled. In this way, the cable and the circuit board of the server architecture may interoperate.

Logic of a memory circuitry of a component (such as to a motherboard, a backplane, a signal extender, a re-timer device, a port, etc.) for example of a server architecture, or the memory circuitry, may be “configured” to the component by being configured to interoperate with that component (the memory circuitry associated with that component to be distinguished from the “memory circuitry” that is part of cable structure according to some embodiments, and that stores cable information thereon as described in the context of the instant disclosure).

“Cable information” as referred to herein includes information about the cable.

In the instant description, although embodiments may be discussed in the context of a modular server architecture, embodiments and any definitions provided herein are not so limited, and include within their scope a server that is not modular or disaggregated.

Cable connection for signal connectivity plays a role in the modular design concept for interconnection among blocks of a disaggregated server architecture. In the state of the art, there is no mechanism to facilitate or ensure sound cable integration, or a mapping matrix to map a given cable to a BIOS configuration for one or more circuit boards interconnected by way of a new cable. Currently, as already noted above, there exist approaches to detect the ID of a circuit board through an circuit board ID pin, or to detect FRU information regarding the circuit board based on a chip integrated on the circuit board and including the FRU information. Identifying the circuit board, including its FRU information are to ensure that a correct server chassis configuration, firmware, flash, manufacturing process and thermal policy are implemented for the chassis based on circuit board FRU information.

Embodiments allow a modular server to be able to detect cable information for integration into the modular server architecture in order to be able to adjust circuit board settings in an adaptive manner as the modular server configuration is changed based on workload requirements.

In the state of the art, for a modular server architecture, even if circuit boards of respective components of the modular server architecture, such as backplanes or PCIes extender cards, share the exact same PCBA, they would be maintained as different SKUs with different FRU or SI settings due to their different locations, to different cable lengths connected to individual ones of the circuit boards, and/or to different expected cables losses for individual ones of the circuit boards. Thus, for field repurposing, a customer would need to purchase different SKUs for different locations even if the related circuit board have a same PCBA.

For a four socket (4S) and for an eight socket (8S) modular server designs, a same CPU UPI port, in the state of the art, would need to be preprogrammed with different BIOS settings for UPI port connections, because of the different cable lengths between modular connections as between the 4S and the 8S scenarios.

Some embodiments allow detection of cable information to facilitate cable connection for system integration in a modular server architecture.

First, system integration of a disaggregated server architecture becomes challenging especially where a given modular server architecture is changed, in which case one or more cables used in the server's configuration prior to the change can cause a mismatch with respect to system integration with circuit boards that are coupling to the cable for data or power transport.

Second, extender circuit boards with PCIe re-timers are typically to be maintained as different SKUs based on different SI (signal integrity) parameters for different cable lengths coupled to the extender circuit boards, based on different server configurations, and/or based on server repurposing at a customer's site.

Third, similarly, backplanes are typically to be maintained as different SKUs with corresponding FRUs or IDs based on their different locations in a server chassis, based on different server configurations, and/or based on server repurposing at a customer's site. The different SKUs for a same circuit board design connected to different cables would need to be kept up to date to ensure that logic on a circuit board to be configured based on information regarding the cable, in this manner ensuring that there is a match between the cable and the logic. Maintaining changing circuit boards with different SKUs in complexity with respect to network maintenance and further increases cost.

Fourth, in a same manner, a BIOS at a circuit board is typically to be pre-programmed by the manufacturer of the server component (in a non-adaptive manner) for different input/output settings for Flex I/O ports, and to be at different SI settings depending on the port protocol to be used. The configured SI settings for a Flex I/O port at the BMC may be detected at a backplane by a resistor set or by SKU programming provided by a manufacturer of the backplane. Such programming is in any event not adaptive in the state of the art (e.g., it does not change based on changes to the server structure configuration). A manufacturer would need to make different circuit boards, such as motherboards, backplanes, PCIe re-timers, having a same hardware configuration, but configured with different SKUs based on anticipated I/O settings of the Flex I/O ports. This makes the provision of a modular server architecture not adaptive to desired server architecture modular changes.

For example, for a Central Processing Unit (CPU) flexible Input/Output (Flex I/O) signaling channel that may be adapted to signal using any one of the Ultra Path Interconnect (UPI), Compute Express Link (CXL) or PCIe interconnect technologies, SKUs and SI settings at the boards are fixed and there is no way to identify the port until an end server component is integrated and powered on.

For example, because a Baseboard Management Controller (BMC) on a motherboard currently is not able to obtain an inventory of cable information, such as FRU information regarding a cable, it is unable to determine whether a wrong cable has been sought to be integrated into the modular server architecture. Its SI settings simply assume a same cable as anticipating during initial programming of the same, which creates a mismatch between the cable actually being used and the SI settings of the BMC. As things stand, the problem of mismatched cables can be detected typically only through functional failures, which negatively impacts server performance.

Some embodiments provide a cable structure for example of a server architecture, wherein the cable structure includes a cable having a first end and a second end, and a cable connector at one of the first end or the second end. The cable structure further includes circuitry disposed on the cable connector, the circuitry to store cable information regarding the cable. The cable information may include, for example, FRU information of the cable (“cable FRU information”). The cable FRU information may include, for example, any one of cable part number, cable version number, cable serial number, cable identification (ID), cable type (e.g., Cat 5e, Cat 6, Cat 6a, Cat 7, Cat 7a, multimode fiber optic, single mode fiber optic, twisted pair, etc.), cable maximum bandwidth, cable maximum frequency, cable maximum speed of transmission (e.g., in Mbps), cable loss/cable attenuation, cable supported interconnect protocol(s), cable length, cable fiber bend radius, a definition of ports to be configured for the cable, such as UPI, PCIe or CXL, cable support matrix, or cable presets. In some embodiments, the circuitry on the cable connector includes a chip.

Some embodiments provide one or more processors of a data center server architecture, such as a disaggregated server architecture. The one or more processors are to access cable information pertaining to a cable coupled to an I/O port of the server architecture. The one or more processors are to configure, logic at a first memory circuitry of the server architecture based on the cable information. According to an embodiment, a cable structure includes the cable, and further includes a second memory circuitry storing the cable information, and accessible by the one or more processors.

Advantageously, according to some embodiments, a circuit board of a server architecture may be configured to use the cable information to predict any integration problem with respect to the cable during set up of the server architecture, to set different SI parameters for a CPU port or re-timer based on changes to a server architecture, to program different SI parameters for a same backplane as between different locations (within a data center, or at different client site locations), to name a few examples.

For example, first, advantageously, a circuit board according to some embodiments may be able to detect any integration problems with respect to any cables installed, or to be installed, at an integration site of the manufacturer of a modular server architecture, in this manner mitigating functional failures caused on the customer side with respect to the installation of mismatched cabling.

In addition, second, advantageously, a circuit board such as a high-speed signal extender (or “signal extender”) within a modular server architecture, according to some embodiments, may be able to be adaptively configured/programmed with different SI settings based on cable information from the circuitry storing the cable information. In this manner, a mechanism according to some embodiments can reduce signal extender SKUs and save cost. More particularly, a same signal extender with a same physical architecture can be kept within the server architecture and adaptively repurposed with different SI settings without the need to switch to a different signal extender with a different SKU each time SI settings need to be changed. In this manner, a server architecture configuration may be changed and fitted with different cabling as needed by the customer quicky and adaptively, leading to faster performance and less system down time.

In addition, third, advantageously, a circuit board such as a backplane or motherboard within a modular server architecture, according to some embodiments, may be able to be adaptively programmed with different SI settings or FRU information based on cable information from the circuitry storing the cable information. In this manner, a mechanism according to some embodiments can reduce backplane or motherboard SKUs and save cost. More particularly, a same backplane or motherboard with a same physical architecture can be kept within the server architecture and adaptively repurposed with different SI settings without the need to switch to a different circuit boards with a different SKU each time SI settings or FRU information need to be changed. In this manner, a server architecture may be changed and fitted with different cabling as needed by the customer quicky and adaptively, leading to faster performance and less system down time.

An addition, fourth, advantageously, a circuit board, such as a motherboard, according to some embodiments, may be adapted to reconfigure, in an adaptive manner, a Flex I/O port to any communication protocol to which the Flex I/O port is configurable to. For example, a circuit board, such as a motherboard, may reconfigure a Flex I/O port to be able to communicate using PCIe, or using CXL, or using UPI, based on cable information that is detected for that port. A circuit board according to some embodiments may provide a single BIOS image with different adaptive settings, which can improve customer experience and save cost in the same manners described above.

As suggested previously, some embodiments provide a self-describing cable structure for a server architecture, that is, a cable structure for a server architecture, where the cable structure includes circuitry storing cable information regarding the cable thereon implementation in server system.

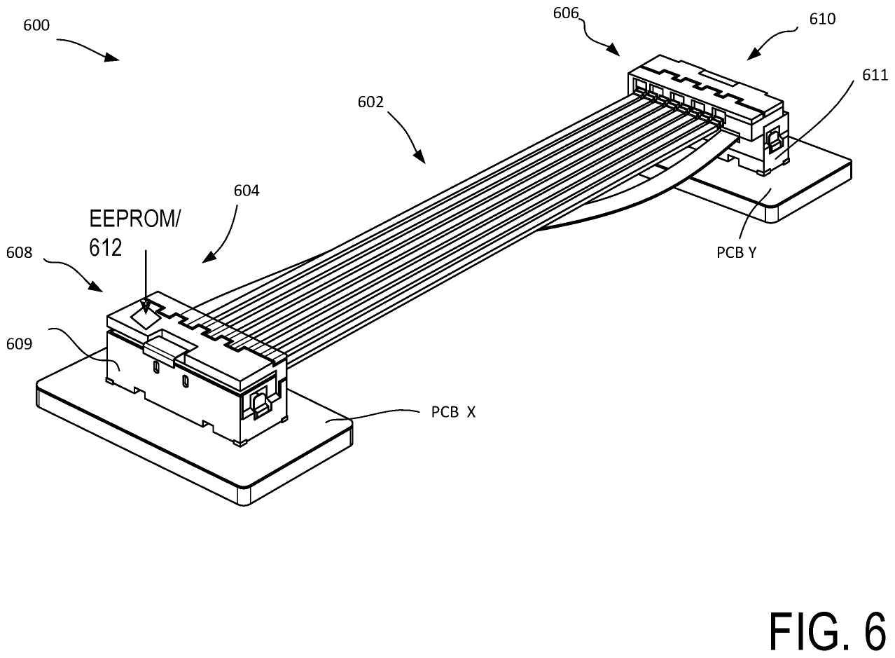

FIGS. 1-12 will now be addressed below. FIGS. 1-5 relate to example architectures for a modular or disaggregated server environment, and FIGS. 6-12 relate to specific examples of some embodiments.

Examples Architectures

FIGS. 1-5 show example architectures that may be used in the context of embodiments, which embodiments will be described in further detail in relation to FIGS. 6-12.

FIG. 1 illustrates a conceptual overview of a data center 100 that may generally be representative of a data center or other type of computing network in/for which one or more techniques described herein may be implemented according to various embodiments. As shown in FIG. 1, data center 100 may generally contain a plurality of racks, each of which may house computing equipment comprising a respective set of physical resources. In the particular non-limiting example depicted in FIG. 1, data center 100 contains four racks 102A to 102D, which house computing equipment comprising respective sets of physical resources 105A to 105D. According to this example, a collective set of physical resources 106 of data center 100 includes the various sets of physical resources 105A to 105D that are distributed among racks 102A to 102D. Physical resources 106 may include resources of multiple types, such as—for example—processors, co-processors, accelerators, field-programmable gate arrays (FPGAs), memory, and storage. The embodiments are not limited to these examples.

In the illustrative embodiment, the circuit boards (“sleds”) on which components such as CPUs, memory, and other components may be placed may be designed for increased thermal performance. In particular, in the illustrative embodiment, the sleds may be shallower than typical circuit boards. In other words, the sleds may be shorter from the front to the back, where cooling fans may be located. This decreases the length of the path that air must to travel across the components on the circuit board. Further, the components on the sled may be spaced further apart than in typical circuit boards, and the components may be arranged to reduce or eliminate shadowing (i.e., one component in the air flow path of another component). In the illustrative embodiment, processing components such as the processors may be located on a top side of a sled while near memory, such as Dual In-line Memory Modules (DIMMs), may be located on a bottom side of the sled. As a result of the enhanced airflow provided by this design, the components may operate at higher frequencies and power levels than in typical systems, thereby increasing performance. Furthermore, the sleds may be configured to blindly mate with power and data communication cables in each rack 102A, 102B, 102C, 102D, enhancing their ability to be quickly removed, upgraded, reinstalled, and/or replaced. Similarly, individual components located on the sleds, such as processors, accelerators, memory, and data storage drives, may be configured to be easily upgraded due to their increased spacing from each other. In the illustrative embodiment, the components additionally include hardware attestation features to prove their authenticity.

Furthermore, in the illustrative embodiment, the data center 100 may utilize a single network architecture (“fabric”) that supports multiple other network architectures including Ethernet and Omni-Path. The sleds, in the illustrative embodiment, may be coupled to switches via optical fibers, which provide higher bandwidth and lower latency than typical twisted pair cabling (e.g., Category 5, Category Se, Category 6, etc.). Due to the high bandwidth, low latency interconnections and network architecture, the data center 100 may, in use, pool resources, such as memory, accelerators (e.g., graphics accelerators, FPGAs, Application Specific Integrated Circuits (ASICs), etc.), and data storage drives that may be physically disaggregated, and provide them to compute resources (e.g., processors) on an as needed basis, enabling the compute resources to access the pooled resources as if they were local. The illustrative data center 100 additionally receives usage information for the various resources, predicts resource usage for different types of workloads based on past resource usage, and dynamically reallocates the resources based on this information.

The racks 102A, 102B, 102C, 102D of the data center 100 may include physical design features that facilitate the automation of a variety of types of maintenance tasks. For example, data center 100 may be implemented using racks that may be designed to be robotically-accessed, and to accept and house robotically manipulatable resource sleds. Furthermore, in the illustrative embodiment, the racks 102A, 102B, 102C, 102D include integrated power sources that receive a greater voltage than is typical for power sources. The increased voltage enables the power sources to provide additional power to the components on each sled, enabling the components to operate at higher than typical frequencies.

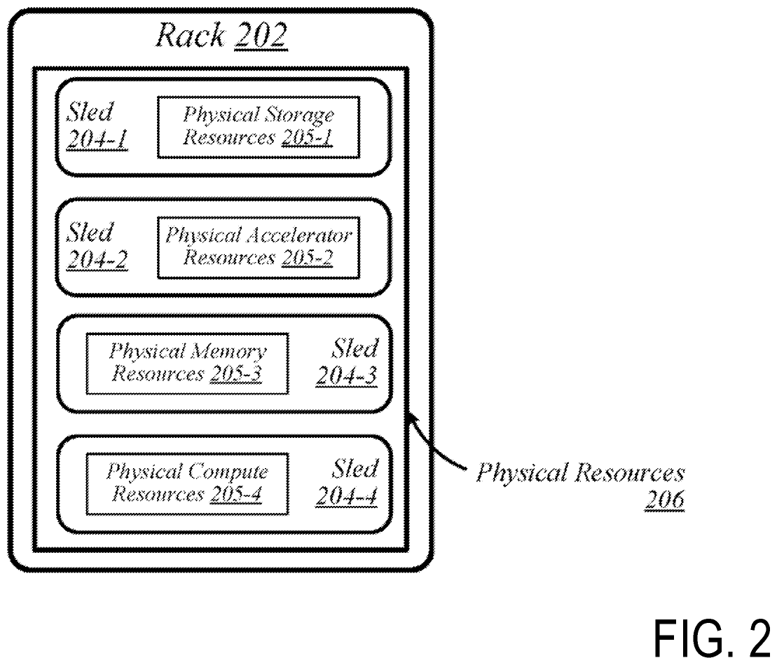

FIG. 2 illustrates an exemplary logical configuration of a rack 202 of the data center 100. As shown in FIG. 2, rack 202 may generally house a plurality of sleds, each of which may comprise a respective set of physical resources. In the particular non-limiting example depicted in FIG. 2, rack 202 houses sleds 204-1 to 204-4 comprising respective sets of physical resources 205-1 to 205-4, each of which constitutes a portion of the collective set of physical resources 206 comprised in rack 202. With respect to FIG. 1, if rack 202 is representative of—for example—rack 102A, then physical resources 206 may correspond to the physical resources 105A comprised in rack 102A. In the context of this example, physical resources 105A may thus be made up of the respective sets of physical resources, including physical storage resources 205-1, physical accelerator resources 205-2, physical memory resources 205-3, and physical compute resources 205-5 comprised in the sleds 204-1 to 204-4 of rack 202. The embodiments may be not limited to this example. Each sled may contain a pool of each of the various types of physical resources (e.g., compute, memory, accelerator, storage). By having robotically accessible and robotically manipulatable sleds comprising disaggregated resources, each type of resource can be upgraded independently of each other and at their own optimized refresh rate.

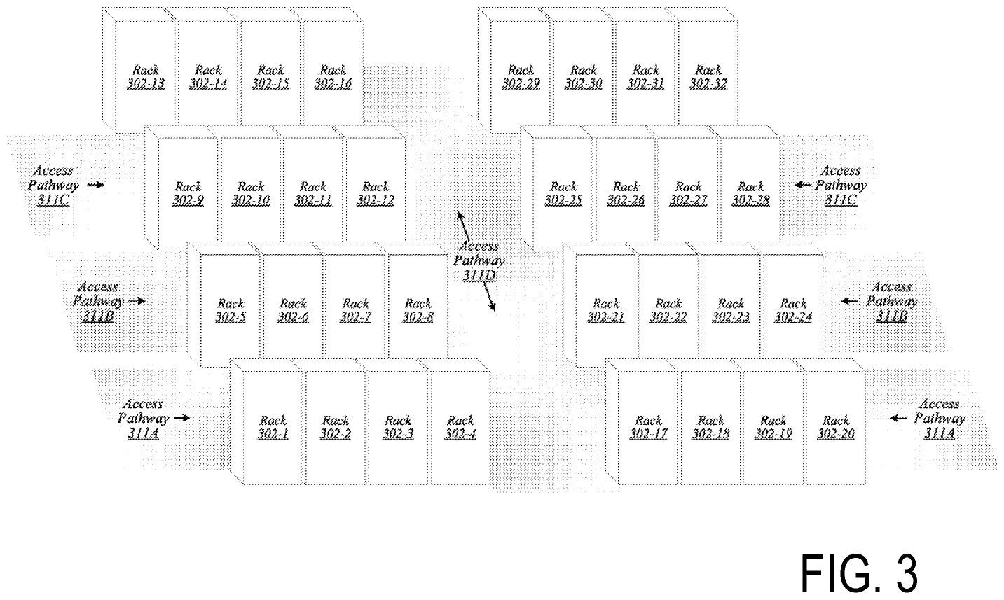

FIG. 3 illustrates an example of a data center 300 that may generally be representative of one in/for which one or more techniques described herein may be implemented according to various embodiments. In the particular non-limiting example depicted in FIG. 3, data center 300 comprises racks 302-1 to 302-32. In various embodiments, the racks of data center 300 may be arranged in such fashion as to define and/or accommodate various access pathways. For example, as shown in FIG. 3, the racks of data center 300 may be arranged in such fashion as to define and/or accommodate access pathways 311A, 311B, 311C, and 311D. In some embodiments, the presence of such access pathways may generally enable automated maintenance equipment, such as robotic maintenance equipment, to physically access the computing equipment housed in the various racks of data center 300 and perform automated maintenance tasks (e.g., replace a failed sled, upgrade a sled). In various embodiments, the dimensions of access pathways 311A, 311B, 311C and 311D, the dimensions of racks 302-1 to 302-32, and/or one or more other aspects of the physical layout of data center 300 may be selected to facilitate such automated operations. The embodiments may be not limited in this context.

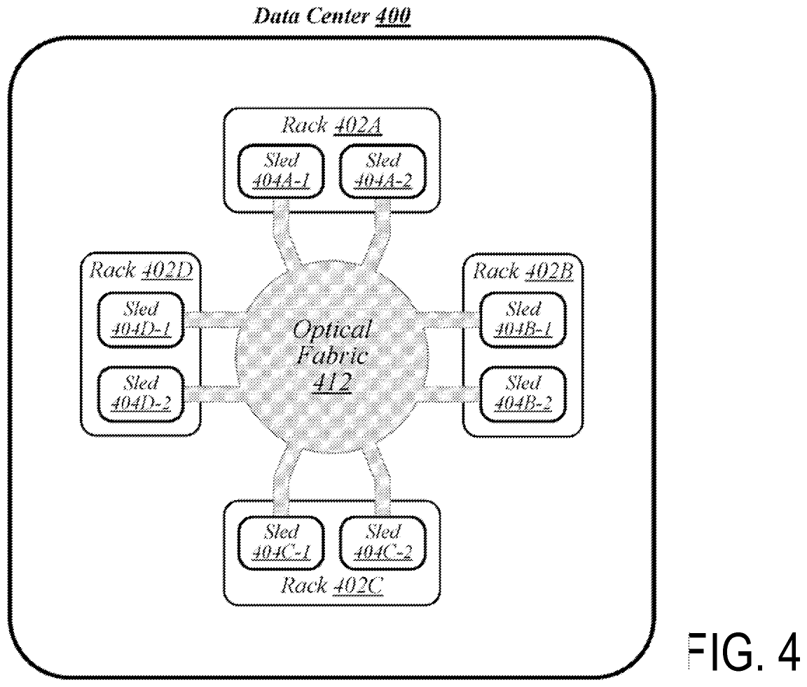

FIG. 4 illustrates an example of a data center 400 that may generally be representative of one in/for which one or more techniques described herein may be implemented according to various embodiments. As shown in FIG. 4, data center 400 may feature an optical fabric 412. Optical fabric 412 may generally comprise a combination of optical signaling media (such as optical cabling) and optical switching infrastructure via which any particular sled in data center 400 can send signals to (and receive signals from) each of the other sleds in data center 400. The signaling connectivity that optical fabric 412 provides to any given sled may include connectivity both to other sleds in a same rack and sleds in other racks. In the particular non-limiting example depicted in FIG. 4, data center 400 includes four racks 402A to 402D. Racks 402A to 402D house respective pairs of sleds 404A-1 and 404A-2, 404B-1 and 404B-2, 404C-1 and 404C-2, and 404D-1 and 404D-2. Thus, in this example, data center 400 comprises a total of eight sleds. Via optical fabric 412, each such sled may possess signaling connectivity with each of the seven other sleds in data center 400. For example, via optical fabric 412, sled 404A-1 in rack 402A may possess signaling connectivity with sled 404A-2 in rack 402A, as well as the six other sleds 404B-1, 404B-2, 404C-1, 404C-2, 404D-1, and 404D-2 that may be distributed among the other racks 402B, 402C, and 402D of data center 400. The embodiments may be not limited to this example.

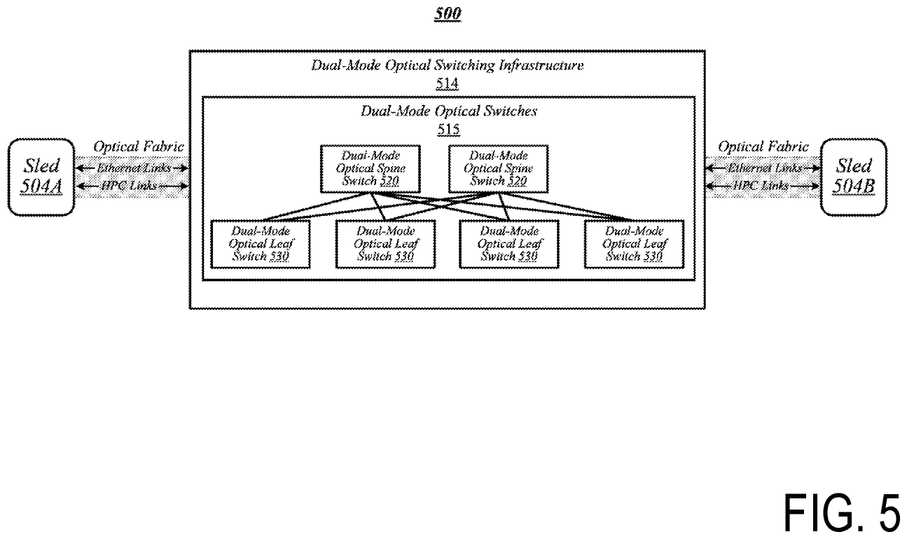

FIG. 5 illustrates an overview of a connectivity scheme 500 that may generally be representative of link-layer connectivity that may be established in some embodiments among the various sleds of a data center, such as any of example data centers 100, 300, and 400 of FIGS. 1, 3, and 4. Connectivity scheme 500 may be implemented using an optical fabric that features a dual-mode optical switching infrastructure 514. Dual-mode optical switching infrastructure 514 may generally comprise a switching infrastructure that is capable of receiving communications according to multiple link-layer protocols via a same unified set of optical signaling media, and properly switching such communications. In various embodiments, dual-mode optical switching infrastructure 514 may be implemented using one or more dual-mode optical switches 515. In various embodiments, dual-mode optical switches 515 may generally comprise high-radix switches. In some embodiments, dual-mode optical switches 515 may comprise multi-ply switches, such as four-ply switches. In various embodiments, dual-mode optical switches 515 may feature integrated silicon photonics that enable them to switch communications with significantly reduced latency in comparison to conventional switching devices. In some embodiments, dual-mode optical switches 515 may constitute leaf switches 530 in a leaf-spine architecture additionally including one or more dual-mode optical spine switches 520.

In various embodiments, dual-mode optical switches may be capable of receiving both Ethernet protocol communications carrying Internet Protocol (IP packets) and communications according to a second, high-performance computing (HPC) link-layer protocol (e.g., Intel's Omni-Path Architecture's, Infiniband) via optical signaling media of an optical fabric. As reflected in FIG. 5, with respect to any particular pair of sleds 504A and 504B possessing optical signaling connectivity to the optical fabric, connectivity scheme 500 may thus provide support for link-layer connectivity via both Ethernet links and HPC links. Thus, both Ethernet and HPC communications can be supported by a single high-bandwidth, low-latency switch fabric. The embodiments may be not limited to this example.

Referring now to FIG. 6, an assembly 600 is shown including a cable structure 601 of a server architecture connecting two PCBs PCB X and PCB Y according to one embodiment. The cable structure 601 includes a cable 602 including a first end 604 and a second end 606. A first cable connector 608 is coupled to the first end 602, and a second cable connector 610 is coupled to the second end 604. Cable connectors 608 and 610 are coupled to respective circuit boards PCA A and PCB X in a manner to establish communicative coupling between PCB X and PCB Y. For example, cable connectors 608 and 610 may include contacts, such as signal contacts and/or power contacts (not shown). The contacts of the cable connectors are coupled to respective buses 609 and 611 compatible therewith, which buses provide coupling between the cable 602 and between the EEPROM 612 on the one hand, and PCB X and PCB Y on the other hand. The PCBs of FIG. 6 may include any circuit board of a server architecture, such as a motherboard, a backplane, an extender including re-timer functionality, etc. The cable structure 601 of FIG. 6 is a self-describing cable structure, in that it includes the provision of circuitry 612 therein that stores cable information. Circuitry 612, in the shown embodiment, includes an electrically erasable programmable read-only memory (EEPROM) chip embedded on cable connector 604. The EEPROM can be programmed to store cable FRU information. The cable FRU information may be accessible through PCB X and/or PCB Y in order to configure SI settings of the respective PCBs, or to allow one or more of the PCBs to configure other PCBs within the corresponding server architecture. Each of PCB X and PCB Y may include an EEPROM that stores FRU information on those PCBs proper.

Although the memory circuitry (e.g., EEPROM) of FIG. 6 is shown on a cable connector, embodiments are not limited, and include within their scope the provision of the memory circuitry anywhere on the cable structure, including on the cable itself.

Some embodiments contemplate at least two implementations for communication between the memory circuitry of a cable structure, such as an EEPROM, on one hand, and system management chips of circuit boards of a server architecture, such as a BMC. The individual ones of the two implementations may require different pins of the connectors and cables.

In particular, according to a first example implementation, for a cable that carries power signals, its corresponding memory circuitry may for example be implemented with one or more signal contacts (e.g., pins) compatible with buses to allow communication based on one or more 2-wire protocols, such as, for example, one or more of an Inter-Integrated Circuit (I2CP) protocol, a Power Management Bus (PMBUS) protocol, or a system management (SMBUS) protocol. The memory circuitry may have power contacts (e.g., power pins) or, for certain cables are already compatible with a 2-wire communication protocol bus (e.g., power and data-based communication protocol) (such as I2C, PMBUS or SMBUS), some embodiments including reusing the cable power signal without adding new power contacts to the memory circuitry.

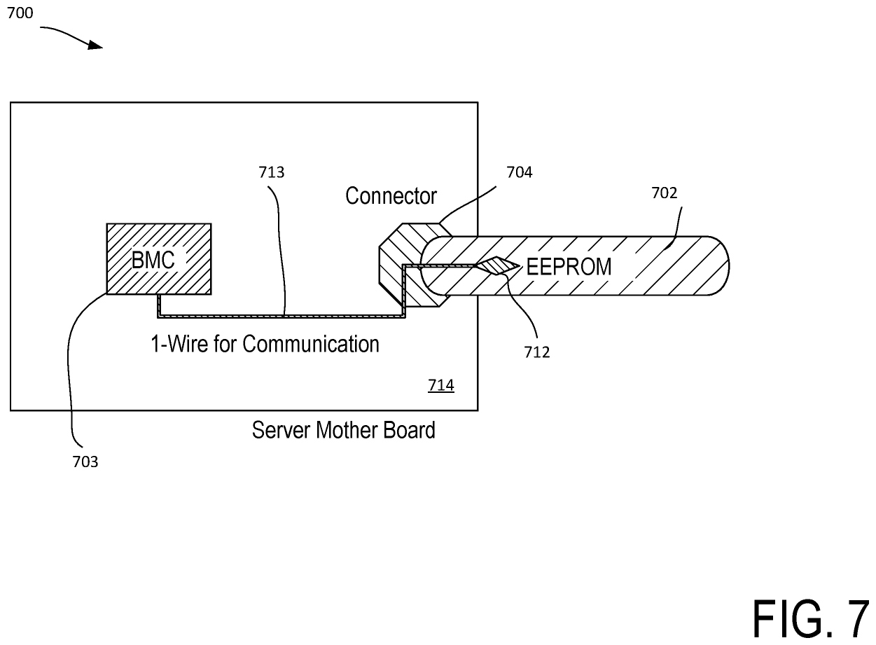

The assembly 700 of FIGS. 7 shows an example of a part of assembly 600 of FIG. 6, including the cable 702, connector 704, EEPROM 712, PCB X in the form of a server motherboard 703 including a BMC 716, and a 1-wire communication 713 between the EEPROM 712 and the BMC 716.

In particular, according to a second example implementation, as shown by way of example in the embodiment of FIG. 7, for a cable 702 that is not to carry power signals in assembly 700, its corresponding memory circuitry 712 may for example be implemented with one or more signal contacts compatible with buses that allow communication based on a 1-wire communication protocol. The 1-wire communication protocol provides a hardware and software design that allows communication between a circuitry, such as the memory circuitry corresponding to EEPROM 712, and one or more other integrated circuits , such as BMC 716 of PCB X, using a single wire (excluding ground, and if needed, a power rail).

According to some embodiments, one or more processors of a first circuit board of a server architecture (such as, for example, a BMC of PCB X) may be configured with firmware to read cable information on a cable coupled to the first circuit board from a memory circuitry of a cable structure that includes the cable, and further to read FRU information on another circuit board connected at an end of the cable. For example, a BMC of PCB X may include firmware the read cable information on cable 602, and further firmware to read FRU information on PCB Y.

According to some embodiments, with self-describing cable structures, server management systems, such as processing circuitry on circuit boards of the corresponding server architecture, are to adaptively manage the server architecture as its configuration changes by programming SI settings of the circuit boards based on cable information they access. The cable information may pertain to cables that are part of the changed server architecture.

Four scenarios regarding how a server management system may use cable information from a memory circuitry of a cable structure according to some example embodiments are described below in relation to FIGS. 14, 15, 16 and 17.

The “memory circuitries” in FIGS. 14-17 correspond to memory circuitries of a cable structure that store cable information thereon.

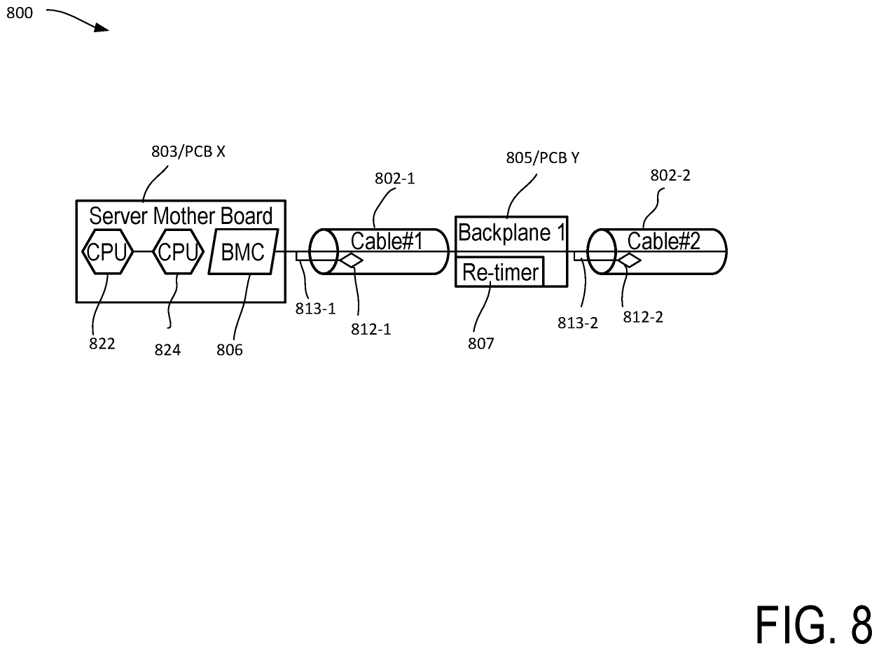

According to a first example scenario, scenario 1, an assembly 800 is shown in FIGS. 8. Assembly 800 includes a first cable 802-1 (of type “cable #1”), and a second cable 802-2 (of type “cable #2), with these cables being different from one another. Assembly 800 further includes a PCB X in the form of a motherboard 803 including CPUs 822 and 824, and a BMC 806. First cable 802-1, and second cable 802-2 include, respectively, memory circuitry 812-1, and memory circuitry 812-2. The memory circuitry 812-1 may be in communication with the motherboard 803 by way of a communication path 813-1. The memory circuitry 812-2 may be in communication with a PCB Y (in the form of a backplane 805 (of type “Backplane 1”)) by way of communication path 813-2. BMC 806 may store information including a mapping between various backplane types and their compatible cable types. For example, BMC 806 may include a mapping that shows, among other entries, that a backplane of type “Backplane 1” may be compatible with a cable of type “cable 1” and a cable of type “cable 2.”

The communication paths 813-1 and 813-2 may each include 1-wire or 2-wire communication paths, by way of example. The communication paths 813-1 and 813-2 may be coupled to respective contacts of the memory circuitries 812-1 and 812-2.

The backplane 805 may include a re-timer device 140. The re-timer device 807 is to ensure signal integrity for various communication protocols such as PCIe and CXL interconnects. The re-timer device may include a mixed-signal analog/digital device that is protocol aware and has the ability to extract the embedded clock, fully recover the data, and retransmit a fresh copy of the data using a clean clock. A re-timer device may compensate for long-term impulse response impairments, and act as a nonlinear equalizer, suppressing any inter-symbol interference (ISI) from channel imperfections such as high-frequency losses and notches.

Cable #1 is to be coupled between motherboard 803 and Backplane 1. Cable #2 is to be coupled to Backplane 1 and another PCB (not shown).

According to an example embodiment, BMC 806 is to access cable information from any one of memory circuitries 812-1 or 812-2, and to use such cable information to detect a mismatch between any of Cables #1 or #2, and any of circuit boards coupled thereto, such as motherboard 803 and Backplane 1 for Cable #1, and such as Cable #1 (and the other PCB not shown) or Cable #2. For example, BMC 806 may be configured to detect whether Cable #1 is the correct cable for the specific port of BMC 806 to which Cable #1 is coupled. BMC 806 may further be configured to detect whether Cable #1 and Cable #2 are each matched in the configuration matrix, that is, whether Cable #1 is not only the correct cable for the port of the BMC 806 mentioned above, but also for the re-timer 807 of Backplane 1, and further whether Cable #2 is the correct cable for the Backplane 1. The BMC may access the cable configuration for Cables #1 and #2 in order to make the above detections, for example by comparing the cable information to a mapping between the port mentioned above and corresponding cables that are matched thereto, between the Backplane 1 and corresponding cables that are matched thereto. The BMC may implement the above for example in a factory setting where the server architecture that includes assembly 800 is being built/integrated.

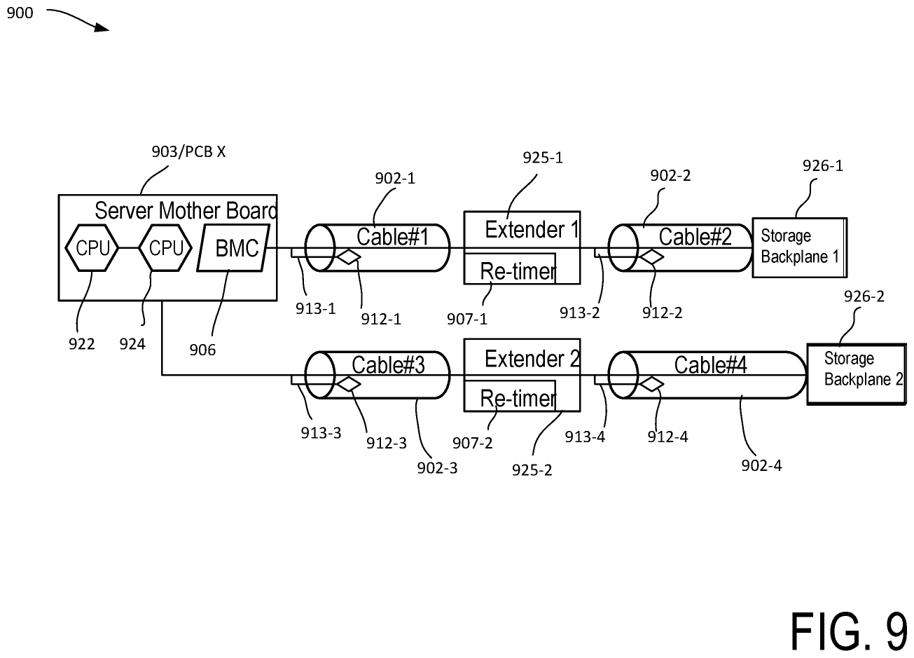

According to a second example scenario, scenario 2, an assembly 900 is shown in FIGS. 9. Assembly 900 includes a first cable 902-1 (of type “cable #1”), a second cable 902-2 (of type “cable #2), a third cable 902-3 (”cable #3″) and a fourth cable 902-4 (“cable #4”), with these cables being different from one another. Assembly 900 further includes a PCB X in the form of a motherboard 903 including CPUs 922 and 924, and a BMC 906. First cable 902-1, second cable 902-2, third cable 902-3 and fourth cable 902-4 include, respectively, memory circuitry 912-1, memory circuitry 912-2, memory circuitry 912-3 and memory circuitry 912-4. The memory circuitry 912-1 may be in communication with the motherboard 903 by way of a communication path 913-1. The memory circuitry 912-2 may be in communication with a PCB Y (in the form of a signal extender 925-1 (of type “Extender 1”)) and the motherboard 903, by way of communication path 913-2. The memory circuitry 912-3 may be in communication with the motherboard 903 by way of a communication path 913-3. The memory circuitry 912-4 may be in communication with signal extender 925-2 (of type “Extender 2”)) and the motherboard 903, by way of communication path 913-4. BMC 906 may store information including a mapping between various signal extender types and their compatible cable types. For example, BMC 906 may include a mapping that shows, among other entries, that a signal extender of type “Extender 1” may be compatible with a cable of type “cable 1” and a cable of type “cable 2.”

The communication paths 913-1, 913-2, 913-3 and 913-4 may each include 1-wire or 2-wire communication paths, by way of example. The communication paths 913-1, 913-2, 913-3 and 913-4 may be coupled to respective contacts of the memory circuitries 912-1, 912-2, 912-3 and 912-4.

The signal extenders 925-1 and 925-2 may respectively include a re-timer devices 907-1 and 907-2s. The re-timer device 907-1 and 907-2 are each to ensure signal integrity for various communication protocols such as PCIe and CXL interconnects. The re-timer devices may each include a mixed-signal analog/digital device that is protocol aware and has the ability to extract the embedded clock, fully recover the data, and retransmit a fresh copy of the data using a clean clock. A re-timer device may compensate for long-term impulse response impairments, and act as a nonlinear equalizer, suppressing any inter-symbol interference (ISI) from channel imperfections such as high-frequency losses and notches.

Cable #1 is to be coupled between motherboard 903 and Extender 1. Cable #2 is to be coupled between Extender 1 and another PCB in the form of a storage backplane 926-1 (of type “Backplane 1”). Cable #3 is to be coupled between motherboard 903 and Extender 2. Cable #4 is coupled between Extender 2 and another PCB in the form of a storage backplane 926-2 (of type “Backplane 2”).

According to an example embodiment, BMC 906 is to access cable information from any one of memory circuitries 912-1, 912-2, 912-3 or 912-4, and to use such cable information to cause a programming of SI settings in corresponding ones of the BMC 906, Extender 1, Extender 2, or storage circuit boards in the form of Backplane 1 and Backplane 2. For example, where, in the embodiment of FIGS. 9, Extenders 1 and 2 have a same hardware configuration, they may be configured with different SI settings based on the fact that they are in different locations of the server architecture, and further based on the fact that they have respective ports connected to Cable #2 and Cable #4, with the latter two cables being different from one another. Where Cable #2 and Cable #4 are associated with different cable information, such as, for example, different cable lengths (e.g., as shown, with Cable #4 being longer than Cable #2), Extenders 1 and 2 may be configured with different SI settings, for example by BMC 906. The SI settings on Extender 2 and corresponding to Cable #4 may need to be more aggressive than the SI settings on Extender 1 and corresponding to Cable #2 because Cable #4 is longer than Cable #2.

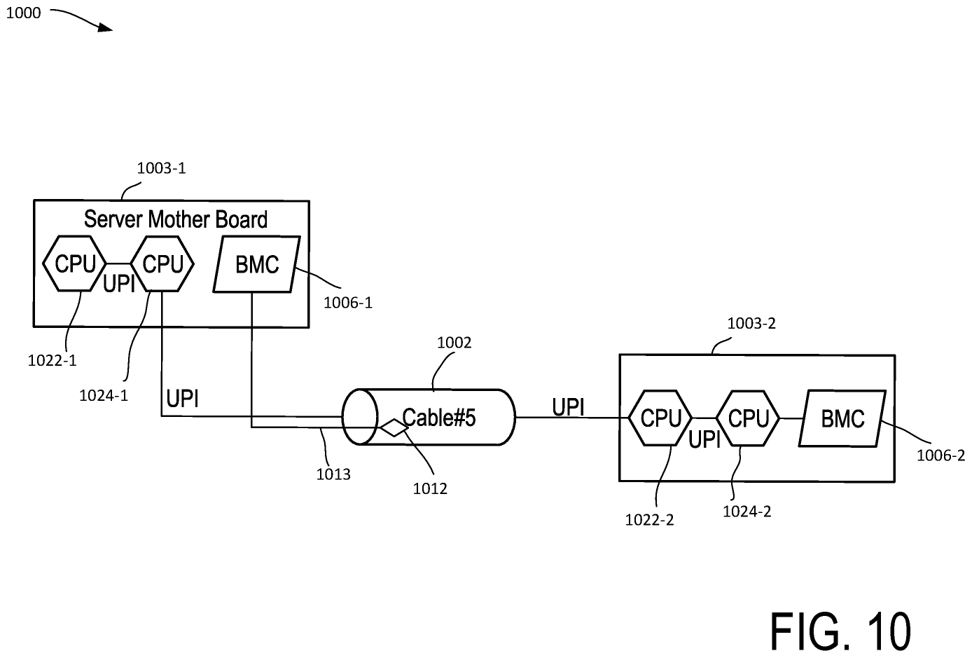

According to a third example scenario, scenario 3, an assembly 1000 is shown in FIGS. 10. Assembly 1000 includes a cable 1002-1 (of type “cable #5”). Assembly 1000 further includes a PCB X in the form of a first motherboard 1003-1 including CPUs 1022-1 and 1024-1, and a BMC 1006-1, and a PCB Y in the form of a second motherboard 1003-2 including CPUs 1022-2 and 1024-2, and a BMC 1006-2.

Cable 1002 includes memory circuitry 1012-1. The memory circuitry 1012 is in communication with the motherboard 1003-1 by way of a communication path 1013. BMC 1006-1 may store information including a mapping between various motherboard ports and their compatible cable types. For example, BMC 1006 may include a mapping that shows, among other entries, that a motherboard port of type UPI may be compatible with a cable of type “cable 5.”

The communication paths 1013 may include a 1-wire or a 2-wire communication path, by way of example. The communication path 1013 may be coupled to a corresponding contact of the memory circuitry 1012.

An assembly having a topology of assembly 1000 in a server architecture may include first motherboard 1003-1 as an upper circuit board, and second motherboard 1003-2 as a lower motherboard, with the assembly representing a 4S configuration. There are typically three kinds of UPI topologies in multi-socket server architectures: a short cable connection, a 4S configuration, and a long cable connection corresponding to an 8S configuration. In the embodiment of FIGS. 10, the 4S configuration is shown between the two motherboards 1003-1 and 1003-2, with a short connection between CPUs 1022-1 and 1024-1 on the one hand, and 1022-2 and 1024-2 on the other hand.

According to an example embodiment, the BMC of one or more of the two motherboards shown in FIGS. 10 is to access cable information from memory circuitry 1012, and to use such cable information, such as cable length and cable loss, in order to configure the BIOS corresponding to the port thereof that is coupled to Cable #5.

Some embodiments include the configuration of respective SI parameters to respective ports of a circuit board, and thus obviate the need for hard-coded BIOS images for different UPI topologies.

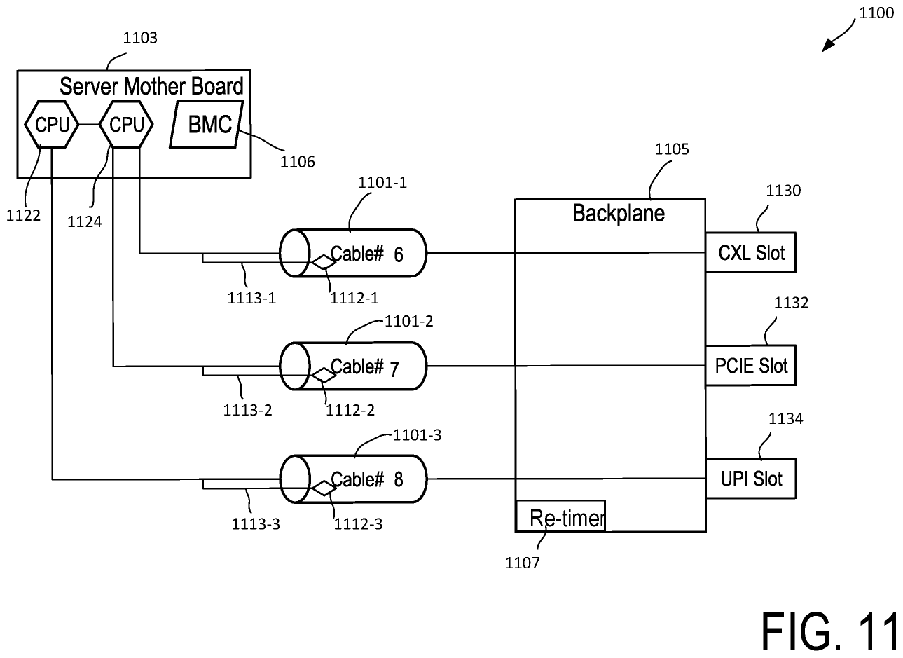

According to a fourth example scenario, scenario 4, an assembly 1100 is shown in FIG. 11. Assembly 1100 includes a first cable 1102-1 (of type “cable #6”), a second cable 1102-2 (of type “cable #7”), and a third cable 1102-3 (“cable #8”), with these cables being different from one another. Assembly 1100 further includes a PCB X in the form of a motherboard 1103 including CPUs 1122 and 1124, and a BMC 1106. First cable 1102-1, second cable 1102-2, and third cable 1102-3 include, respectively, memory circuitry 1112-1, memory circuitry 1112-2, and memory circuitry 1112-3. The memory circuitry 1112-1 may be in communication with the motherboard 1103 by way of a communication path 1113-1. The memory circuitry 1112-2 may be in communication with the motherboard 1103 by way of a communication path 1113-2. The memory circuitry 1112-3 may be in communication with the motherboard 1103 by way of a communication path 1113-3. BMC 1106 may store information including a mapping between various ports of the motherboard, such as a UPI port of CPU 1122, a PCIe port of CPU 1124 and a CXL port of CPU 1124, and their respective compatible cable types. For example, BMC 1106 may include a mapping that shows, among other entries, that Cable #6 corresponds to a CXL communication protocol, Cable #7 corresponds to a PCIe communication protocol, and Cable #8 corresponds to a UPI communication protocol.

The communication paths 1113-1, 1113-2 and 1113-3 may include 1-wire or 2-wire communication paths, by way of example. The communication paths 1113-1, 1113-2 and 1113-3 may be coupled to respective contacts of the memory circuitries 1112-1, 1112-2, and 1112-3.

The backplane 1105 may include a re-timer device 1107. The re-timer device 1107 is to ensure signal integrity for various communication protocols such as PCIe and CXL interconnects. The re-timer device may each include a mixed-signal analog/digital device that is protocol aware and has the ability to extract the embedded clock, fully recover the data, and retransmit a fresh copy of the data using a clean clock. A re-timer device may compensate for long-term impulse response impairments, and act as a nonlinear equalizer, suppressing any inter-symbol interference (ISI) from channel imperfections such as high-frequency losses and notches.

According to an example embodiment, BMC 1106 is to access cable information from any one of memory circuitries 1112-1, 1112-2, or 1112-3, and to use such cable information to cause a programming of SI settings with respect to at least one of ports of the motherboard, or the re-timer. For example, where, in the embodiment of FIGS. 11, the motherboard 1103 includes a Flex I/O port for at least one of CPUs 1122 or 1124, which can support UPI, PCIE and CXL connections, in different server architectures, the Flex I/O port can be configured, based on the cable information detected from a memory circuitry, for different use cases. Even within a same server architecture, a Flex I/O port may be configured to provide a connection with different communication protocols, and/or different corresponding backplanes and end devices. The flex IO port can be programmed as different port based on different cable information detected.

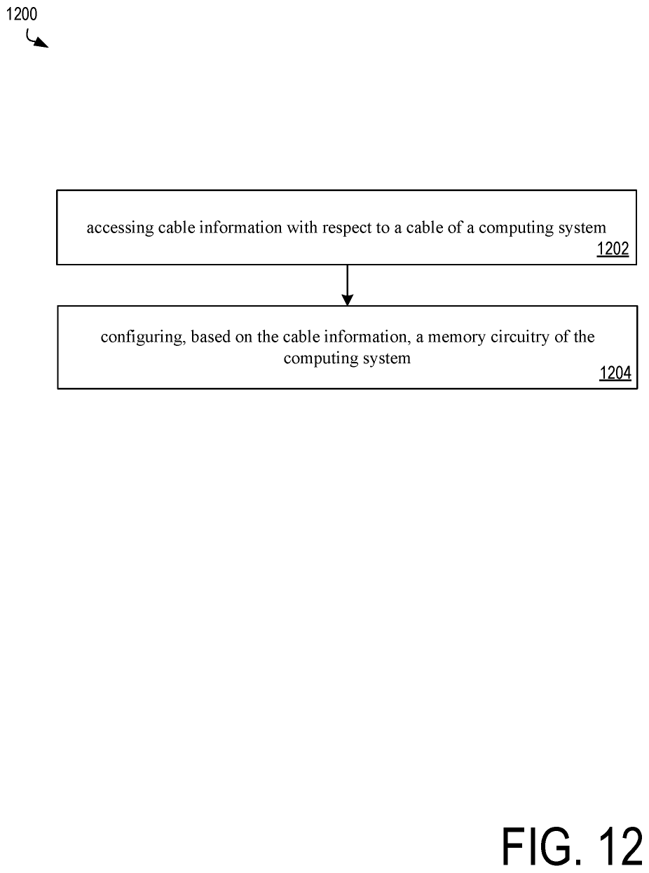

FIG. 12 illustrates a process 1200 to be performed at one or more processors of a circuit board of a computing system. Process 1200 includes, at operation 1202, accessing cable information with respect to a cable of the computing system; and at operation 1204 configuring, based on the cable information, a memory circuitry of the computing system.

According to an example embodiment, one or more cables of a computing system, such as a server architecture, may be replaced robotically, and one or more embodiments may then be implemented to determine configure the system based on the one or more cables, or to report on a mismatch between the one or more cables and one or more corresponding components of the computing system.

Embodiments herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. It is noted that hardware, firmware and/or software elements may be collectively or individually referred to herein as “module,” or “logic.” A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof

According to some examples, a computer-readable medium may include a non-transitory medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores,” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. These terms are not necessarily intended as synonyms for another. For example, descriptions using the terms “connected” and/or “coupled” may indicate that two or more elements are in direct physical or electrical contact with another. The term “coupled,” however, may also mean that two or more elements are not in direct contact with another, but yet still co-operate or interact with another.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to be present. Additionally, conjunctive language such as the phrase “at least one of X, Y, and Z,” unless specifically stated otherwise, should also be understood to mean X, Y, Z, or any combination thereof, including “X, Y, and/or Z.”

Illustrative examples of the devices, systems, and methods disclosed herein are provided below. An embodiment of the devices, systems, and methods may include any one or more, and any combination of, the examples described below.

Flow diagrams as illustrated herein provide examples of sequences of various process actions. The flow diagrams can indicate operations to be executed by a software or firmware routine, as well as physical operations. In some embodiments, a flow diagram can illustrate the state of a finite state machine (FSM), which can be implemented in hardware and/or software. Although shown in a particular sequence or order, unless otherwise specified, the order of the actions can be modified. Thus, the illustrated embodiments should be understood only as an example, and the process can be performed in a different order, and some actions can be performed in parallel. Additionally, one or more actions can be omitted in various embodiments; thus, not all actions are required in every embodiment. Other process flows are possible.

Various components described herein can be a means for performing the operations or functions described. A component described herein includes software, hardware, or a combination of these. The components can be implemented as software modules, hardware modules, special-purpose hardware (e.g., application specific hardware, application specific integrated circuits (ASICs), digital signal processors (DSPs), etc.), embedded controllers, hardwired circuitry, and so forth.

### EXAMPLES

Additional examples of the presently described method, system, and device embodiments include the following, non-limiting implementations. Each of the following non-limiting examples may stand on its own or may be combined in any permutation or combination with any one or more of the other examples provided below or throughout the present disclosure.

Example 1 includes a circuit board of a computing system, the circuit board including a plurality of input and output ports (I/O ports) and one or more processing circuitries coupled to the I/O ports, the one or more processing circuitries to: access cable information pertaining to a cable coupled to one of the I/O ports; and configure, based on the cable information, a memory circuitry of the computing system.

Example 2 includes the subject matter of Example 1, wherein the cable information includes at least one of a cable part number, a cable version number, a cable serial number, a cable identification (ID), a cable type, a cable maximum bandwidth, a cable maximum frequency, a cable maximum speed of transmission, cable loss, one or more cable supported interconnect protocols, cable length, cable width, cable diameter, cable fiber bend radius, or an identification of one or more port protocols configurable to the cable.

Example 3 includes the subject matter of Example 1, wherein configuring the logic includes configuring system integration (SI) settings at the memory circuitry to provide interoperability between the cable and the circuit board.

Example 4 includes the subject matter of Example 3, wherein the SI settings are second SI settings, and configuring the logic includes changing first SI settings stored at the memory circuitry to the second SI settings based on the cable information.

Example 5 includes the subject matter of Example 1, the one or more processors to further detect a mismatch as between the cable and a circuit board that includes the memory circuitry, wherein the circuit board that includes the memory circuitry one of: corresponds to the circuit board of the computing system; or corresponds to another circuit board different from the circuit board of the computing system.

Example 6 includes the subject matter of Example 5, wherein the one or more processors are to further cause generation and transmission of a report based on the mismatch.

Example 7 includes the subject matter of Example 1, wherein the memory circuitry is part of the circuit board.

Example 8 includes the subject matter of Example 1, wherein the circuit board is a first circuit board, and wherein the memory circuitry is part of a second circuit board of the computing system.

Example 9 includes the subject matter of Example 1, wherein the circuit board includes a motherboard of the computing system.

Example 10 includes the subject matter of Example 9, wherein the motherboard includes a Baseboard Management Controller (BMC), and wherein the one or more processing circuitries are processing circuitries of the BMC.

Example 11 includes the subject matter of any one of Examples 1-10, wherein the memory circuitry is a memory circuitry of one of a motherboard, a signal extender, or a backplane of the computing system.

Example 12 includes the subject matter of any one of Examples 1-10, wherein the computing system is a server architecture, the memory circuitry corresponding to a re-timer device of the server architecture.

Example 13 includes the subject matter of any one of Examples 1-10, wherein the computing system is a server architecture, the memory circuitry corresponding to an I/O port.

Example 14 includes the subject matter of Example 13, wherein the logic at the memory circuitry corresponds to one of the I/O ports of the circuit board.

Example 15 includes the subject matter of Example 14, wherein said one of the I/O ports includes a Flexible I/O port (Flex I/O port) configurable to either one of a (UPI), a (PCIe) or a (CXL) communication protocol, and wherein configuring the logic includes configuring the Flex I/O port to either one of the UPI, the PCIe or the CXL communication protocol.

Example 16 includes the subject matter of any one of Examples 1-15, wherein the memory circuitry is a first memory circuitry, and wherein accessing cable information includes accessing the cable information from a second memory circuitry storing the cable information.

Example 17 includes the subject matter of Example 16, wherein accessing the cable information from the second memory circuitry includes sending a read signal to the second memory circuitry, and receiving the cable information based on the read signal.

Example 18 includes the subject matter of Example 16, wherein accessing the cable information includes receiving the cable information using one of a 1-wire protocol or a 2-wire protocol.

Example 19 includes the subject matter of Example 18, wherein the 2-wire protocol includes at least one of an Inter-Integrated Circuit (I2CP) protocol, a Power Management Bus (PMBUS) protocol, or a system management (SMBUS) protocol.

Example 20 includes a server architecture including a motherboard, a circuit board, and a cable structure communicatively coupling the motherboard to the circuit board, wherein: the motherboard includes: a plurality of first input and output ports (I/O ports) and one or more processing circuitries coupled to the first I/O ports, the one or more processing circuitries to: access cable information pertaining to a cable of the cable structure; and configure, based on the cable information, logic at a first memory circuitry; the cable structure includes a second memory circuitry storing the cable information; and the circuit board includes second I/O ports, the cable structure coupling the motherboard to the circuit board by way of the first I/O ports and the second I/O ports.

Example 21 includes the subject matter of Example 20, wherein the cable information includes at least one of a cable part number, a cable version number, a cable serial number, a cable identification (ID), a cable type, a cable maximum bandwidth, a cable maximum frequency, a cable maximum speed of transmission, cable loss, one or more cable supported interconnect protocols, cable length, cable width, cable diameter, cable fiber bend radius, or an identification of one or more port protocols configurable to the cable.

Example 22 includes the subject matter of Example 20, wherein configuring the logic includes configuring system integration (SI) settings at the first memory circuitry to provide interoperability between the cable and a component of the server architecture that includes the first memory circuitry.

Example 23 includes the subject matter of Example 22, wherein the SI settings are second SI settings, and configuring the logic includes changing first SI settings stored at the first memory circuitry to the second SI settings based on the cable information.

Example 24 includes the subject matter of Example 22, the one or more processors to further detect a mismatch as between the cable and the component that includes the first memory circuitry, wherein the component one of corresponds to the motherboard, corresponds to the circuit board coupled to the motherboard through the cable, or corresponds to another circuit board different from the circuit board coupled to the motherboard through the cable.

Example 25 includes the subject matter of Example 24, wherein the one or more processors are to further cause generation and transmission of a report based on the mismatch.

Example 26 includes the subject matter of Example 20, wherein the first memory circuitry is part of the motherboard.

Example 27 includes the subject matter of Example 20, wherein the first memory circuitry is part of the circuit board.

Example 28 includes the subject matter of Example 27, wherein the circuit board includes another motherboard, a signal extender, or a backplane of the server architecture.

Example 29 includes the subject matter of Example 20, wherein the motherboard includes a Baseboard Management Controller (BMC), and wherein the one or more processing circuitries are processing circuitries of the BMC.

Example 30 includes the subject matter of any one of Examples 20-29, wherein the logic at the first memory circuitry corresponds to a re-timer device of the server architecture.

Example 31 includes the subject matter of any one of Examples 20-29, wherein the logic at the first memory circuitry corresponds to an I/O port.

Example 32 includes the subject matter of Example 31, wherein the logic at the first memory circuitry corresponds to one of the first I/O ports.

Example 33 includes the subject matter of Example 32, wherein said one of the first I/O ports includes a Flexible I/O port (Flex I/O port) configurable to either one of a (UPI), a (PCIe) or a (CXL) communication protocol, and wherein configuring the logic includes configuring the Flex I/O port to either one of the UPI, the PCIe or the CXL communication protocol.

Example 34 includes the subject matter of Example 20, wherein accessing the cable information from the second memory circuitry includes sending a read signal to the second memory circuitry, and receiving the cable information based on the read signal.

Example 35 includes the subject matter of Example 34, wherein accessing the cable information includes receiving the cable information using one of a 1-wire protocol or a 2-wire protocol.

Example 36 includes the subject matter of Example 35, wherein the 2-wire protocol includes at least one of an Inter-Integrated Circuit (I2CP) protocol, a Power Management Bus (PMBUS) protocol, or a system management (SMBUS) protocol.

Example 37 includes a non-transitory computer-readable storage medium comprising instructions stored thereon, that when executed by one or more processing circuitries of a circuit board of a computing system, cause the one or more processors to perform instructions including: accessing cable information pertaining to a cable of the computing system; and configuring, based on the cable information, a memory circuitry of the computing system.

Example 38 includes the subject matter of Example 37, wherein the cable information includes at least one of a cable part number, a cable version number, a cable serial number, a cable identification (ID), a cable type, a cable maximum bandwidth, a cable maximum frequency, a cable maximum speed of transmission, cable loss, one or more cable supported interconnect protocols, cable length, cable width, cable diameter, cable fiber bend radius, or an identification of one or more port protocols configurable to the cable.

Example 39 includes the subject matter of Example 37, wherein configuring the memory circuitry includes configuring system integration (SI) settings at the memory circuitry to provide interoperability between the cable and the circuit board.

Example 40 includes the subject matter of Example 39, wherein the SI settings are second SI settings, and configuring the memory circuitry includes changing first SI settings stored at the memory circuitry to the second SI settings based on the cable information.

Example 41 includes the subject matter of Example 37, the operations further including detecting a mismatch as between the cable and a circuit board that includes the memory circuitry, wherein the circuit board that includes the memory circuitry one of corresponds to the circuit board of the computing system, or corresponds to another circuit board different from the circuit board of the computing system.

Example 42 includes the subject matter of Example 41, the operations further including causing generation and transmission of a report based on the mismatch.

Example 43 includes the subject matter of Example 37, wherein the memory circuitry is part of the circuit board.

Example 44 includes the subject matter of Example 37, wherein the circuit board is a first circuit board, and wherein the memory circuitry is part of a second circuit board of the computing system.

Example 45 includes the subject matter of Example 37, wherein the circuit board includes a motherboard of the computing system.

Example 46 includes the subject matter of Example 45, wherein the motherboard includes a Baseboard Management Controller (BMC), and wherein the one or more processing circuitries are processing circuitries of the BMC.

Example 47 includes the subject matter of any one of Examples 37-46, wherein the memory circuitry is a memory circuitry of one of a motherboard, a signal extender, or a backplane of the computing system.

Example 48 includes the subject matter of any one of Examples 37-46, wherein the computing system is a server architecture, the memory circuitry corresponding to a re-timer device of the computing system.

Example 49 includes the subject matter of any one of Examples 37-46, wherein the computing system is a server architecture, the memory circuitry corresponding to an I/O port.

Example 50 includes the subject matter of Example 49, wherein the memory circuitry corresponds to one of the I/O ports of the circuit board.

Example 51 includes the subject matter of Example 50, wherein said one of the I/O ports includes a Flexible I/O port (Flex I/O port) configurable to either one of a (UPI), a (PCIe) or a (CXL) communication protocol, and wherein configuring the memory circuitry includes configuring the Flex I/O port to either one of the UPI, the PCIe or the CXL communication protocol.

Example 52 includes the subject matter of any one of Examples 37-51, wherein the memory circuitry is a first memory circuitry, and wherein accessing cable information includes accessing the cable information from a second memory circuitry storing the cable information.

Example 53 includes the subject matter of Example 52, wherein accessing the cable information from the second memory circuitry includes sending a read signal to the second memory circuitry, and receiving the cable information based on the read signal.

Example 54 includes the subject matter of Example 52, wherein accessing the cable information includes receiving the cable information using one of a 1-wire protocol or a 2-wire protocol.

Example 55 includes the subject matter of Example 54, wherein the 2-wire protocol includes at least one of an Inter-Integrated Circuit (I2CP) protocol, a Power Management Bus (PMBUS) protocol, or a system management (SMBUS) protocol.

Example 56 includes a method to be performed at one or more processors of a circuit board of a computing system, the method including: accessing cable information pertaining to a cable of the computing system; and configuring, based on the cable information, a memory circuitry of the computing system.

Example 57 includes the subject matter of Example 56, wherein the cable information includes at least one of a cable part number, a cable version number, a cable serial number, a cable identification (ID), a cable type, a cable maximum bandwidth, a cable maximum frequency, a cable maximum speed of transmission, cable loss, one or more cable supported interconnect protocols, cable length, cable width, cable diameter, cable fiber bend radius, or an identification of one or more port protocols configurable to the cable.

Example 58 includes the subject matter of Example 56, wherein configuring the logic includes configuring system integration (SI) settings at the memory circuitry to provide interoperability between the cable and the circuit board.

Example 59 includes the subject matter of Example 58, wherein the SI settings are second SI settings, and configuring the logic includes changing first SI settings stored at the memory circuitry to the second SI settings based on the cable information.

Example 60 includes the subject matter of Example 56, further including detecting a mismatch as between the cable and a circuit board that includes the memory circuitry, wherein the circuit board that includes the memory circuitry one of corresponds to the circuit board of the computing system, or corresponds to another circuit board different from the circuit board of the computing system.

Example 61 includes the subject matter of Example 60, further including causing generation and transmission of a report based on the mismatch.

Example 62 includes the subject matter of Example 56, wherein the memory circuitry is part of the circuit board.

Example 63 includes the subject matter of Example 56, wherein the circuit board is a first circuit board, and wherein the memory circuitry is part of a second circuit board of the computing system.

Example 64 includes the subject matter of Example 56, wherein the circuit board includes a motherboard of the computing system.

Example 65 includes the subject matter of Example 64, wherein the motherboard includes a Baseboard Management Controller (BMC), and wherein the one or more processing circuitries are processing circuitries of the BMC.

Example 66 includes the subject matter of any one of Examples 56-65, wherein the memory circuitry is a memory circuitry of one of a motherboard, a signal extender, or a backplane of the computing system.

Example 67 includes the subject matter of any one of Examples 56-65, wherein the memory circuitry corresponds to a re-timer device of the computing system.

Example 68 includes the subject matter of any one of Examples 56-65, wherein the memory circuitry corresponds to an I/O port.

Example 69 includes the subject matter of Example 68, wherein the memory circuitry corresponds to one of the I/O ports of the circuit board.

Example 70 includes the subject matter of Example 69, wherein said one of the I/O ports includes a Flexible I/O port (Flex I/O port) configurable to either one of a (UPI), a (PCIe) or a (CXL) communication protocol, and wherein configuring the logic includes configuring the Flex I/O port to either one of the UPI, the PCIe or the CXL communication protocol.

Example 71 includes the subject matter of any one of Examples 56-70, wherein the memory circuitry is a first memory circuitry, and wherein accessing cable information includes accessing the cable information from a second memory circuitry storing the cable information.

Example 72 includes the subject matter of Example 71, wherein accessing the cable information from the second memory circuitry includes sending a read signal to the second memory circuitry, and receiving the cable information based on the read signal.

Example 73 includes the subject matter of Example 71, wherein accessing the cable information includes receiving the cable information using one of a 1-wire protocol or a 2-wire protocol.

Example 74 includes the subject matter of Example 73, wherein the 2-wire protocol includes at least one of an Inter-Integrated Circuit (I2CP) protocol, a Power Management Bus (PMBUS) protocol, or a system management (SMBUS) protocol.

Example 75 includes a cable structure, the cable structure including: a cable defining a physical communication pathway; a cable connector coupled to an end of the cable; and a memory circuitry on the cable or on the cable connector, the memory circuitry storing cable information thereon.

Example 76 includes the subject matter of Example 75, wherein the cable information includes at least one of a cable part number, a cable version number, a cable serial number, a cable identification (ID), a cable type, a cable maximum bandwidth, a cable maximum frequency, a cable maximum speed of transmission, cable loss, one or more cable supported interconnect protocols, cable length, cable width, cable diameter, cable fiber bend radius, or an identification of one or more port protocols configurable to the cable.

Example 77 includes the subject matter of Example 75, wherein the cable is to communicate at least one of data and power.

Example 78 includes the subject matter of Example 75, further including a contact communicatively coupled to the memory circuitry, the contact being compatible with at least one of a 1-wire communication protocol or a 2-wire communication protocol to communicate cable information from the memory circuitry.

Example 79 includes the subject matter of Example 78, wherein the 2-wire communication protocol includes at least one of an Inter-Integrated Circuit (I2CP) protocol, a Power Management Bus (PMBUS) protocol, or a system management (SMBUS) protocol.

Example 80 includes the subject matter of any one of Examples 75-79, wherein the memory circuitry includes an electrically erasable programmable read only memory (EEPROM).

Example 81 includes the subject matter of any one of Examples 75-79, wherein the memory circuitry includes one or more semiconductor chips.

Example 82 includes the subject matter of any one of Examples 75-81, wherein the cable includes at least one of a fiber optic cable and a metal cable.

1. A circuit board a server architecture, the circuit board including a plurality of input and output ports (I/O ports) and one or more processing circuitries coupled to the I/O ports, the one or more processors to:
access cable information pertaining to a cable coupled to one of the I/O ports; and
configure, based on the cable information, logic at a memory circuitry of the server architecture.

2. The circuit board of claim 1, wherein the cable information includes at least one of a cable part number, a cable version number, a cable serial number, a cable identification (ID), a cable type, a cable maximum bandwidth, a cable maximum frequency, a cable maximum speed of transmission, cable loss, one or more cable supported interconnect protocols, cable length, cable width, cable diameter, cable fiber bend radius, or an identification of one or more port protocols configurable to the cable.

3. The circuit board of claim 1, wherein configuring the logic includes configuring system integration (SI) settings at the memory circuitry to provide interoperability between the cable and the circuit board.

4. The circuit board of claim 3, wherein the SI settings are second SI settings, and configuring the logic includes changing first SI settings stored at the memory circuitry to the second SI settings based on the cable information.

5. The circuit board of claim 1, the one or more processors to further detect a mismatch as between the cable and a circuit board that includes the memory circuitry, wherein the circuit board that includes the memory circuitry one of corresponds to the circuit board of the server architecture, or corresponds to another circuit board different from the circuit board of the server architecture.

6. The circuit board of claim 5, wherein the one or more processors are to further cause generation and transmission of a report based on the mismatch.

7. The circuit board of claim 1, wherein the memory circuitry is part of the circuit board.

8. The circuit board of claim 1, wherein the circuit board is a first circuit board, and wherein the memory circuitry is part of a second circuit board of the server architecture.

9. A server architecture including a motherboard, a circuit board, and a cable structure communicatively coupling the motherboard to the circuit board, wherein:
the motherboard includes:
a plurality of first input and output ports (I/O ports) and one or more processing circuitries coupled to the first I/O ports, the one or more processors to:
access cable information pertaining to a cable of the cable structure; and
configure, based on the cable information, logic at a first memory circuitry;
the cable structure includes a second memory circuitry storing the cable information; and
the circuit board includes second I/O ports, the cable structure coupling the motherboard to the circuit board by way of the first I/O ports and the second I/O ports.

10. The server architecture of claim 9, wherein the first memory circuitry is part of the circuit board.

11. The server architecture of claim 10, wherein the circuit board includes another motherboard, a fabric extender, or a backplane of the server architecture.

12. The server architecture of claim 9, wherein the motherboard includes a Baseboard Management Controller (BMC), and wherein the one or more processors are processing circuitries of the BMC.

13. The server architecture of claim 9, wherein the logic at the first memory circuitry corresponds to a re-timer device of the server architecture.

14. The server architecture of claim 9, wherein the logic at the first memory circuitry corresponds to an I/O port.

15. The server architecture of claim 9, wherein the logic at the first memory circuitry corresponds to one of the first I/O ports.

16. A non-transitory computer-readable storage medium comprising instructions stored thereon, that when executed by one or more processing circuitries of a circuit board of a server architecture, cause the one or more processors to perform operations including:
accessing cable information pertaining to a cable of the server architecture; and
configuring, based on the cable information, logic at a memory circuitry of the server architecture.

17. The storage medium of claim 16, wherein the cable information includes at least one of a cable part number, a cable version number, a cable serial number, a cable identification (ID), a cable type, a cable maximum bandwidth, a cable maximum frequency, a cable maximum speed of transmission, cable loss, one or more cable supported interconnect protocols, cable length, cable width, cable diameter, cable fiber bend radius, or an identification of one or more port protocols configurable to the cable.

18. The storage medium of claim 16, wherein configuring the logic includes configuring system integration (SI) settings at the memory circuitry to provide interoperability between the cable and the circuit board.

19. The storage medium of claim 18, wherein the SI settings are second SI settings, and configuring the logic includes changing first SI settings stored at the memory circuitry to the second SI settings based on the cable information.

20. The storage medium of claim 16, the operations further including detecting a mismatch as between the cable and a circuit board that includes the memory circuitry, wherein the circuit board that includes the memory circuitry one of corresponds to the circuit board of the server architecture, or corresponds to another circuit board different from the circuit board of the server architecture.

21. The storage medium of claim 20, the operations further including causing generation and transmission of a report based on the mismatch.

22. A method to be performed at one or more processors of a circuit board of a server architecture, cause the one or more processors to perform instructions including:
accessing cable information pertaining to a cable of the server architecture; and
configuring, based on the cable information, logic at a memory circuitry of the server architecture.

23. The method of claim 22, wherein the cable information includes at least one of a cable part number, a cable version number, a cable serial number, a cable identification (ID), a cable type, a cable maximum bandwidth, a cable maximum frequency, a cable maximum speed of transmission, cable loss, one or more cable supported interconnect protocols, cable length, cable width, cable diameter, cable fiber bend radius, or an identification of one or more port protocols configurable to the cable.

24. The method of claim 22, wherein configuring the logic includes configuring system integration (SI) settings at the memory circuitry to provide interoperability between the cable and the circuit board, wherein the SI settings are second SI settings, and configuring the logic includes changing first SI settings stored at the memory circuitry to the second SI settings based on the cable information.

25. The method of claim 22, wherein the memory circuitry is a first memory circuitry, and wherein accessing cable information includes accessing the cable information from a second memory circuitry storing the cable information.
